(19) United States
(12) Patent Application Publication
(10) Pub. No.: US 2024/0241335 A1
(43) Pub. Date: Jul. 18, 2024

(54) CABLE STORAGE DEVICE AND METHOD

(71) Applicant: Amprod LLC, Strafford, MO (US)

(72) Inventors: Tim Dudley, Marshfield, MO (US); Bill Biston, Fair Grove, MO (US)

(21) Appl. No.: 18/411,794

(22) Filed: Jan. 12, 2024

Related U.S. Application Data
(60) Provisional application No. 63/438,728, filed on Jan. 12, 2023.

(51) Int. Cl. G02B 6/44

(52) U.S. Cl. CPC G02B 6/4459; G02B 6/4457

(57) ABSTRACT

A cable storage device and method are provided. An embodiment comprises a frame including a spine and two cross-arm members, forming an H-frame shape, and a series of cable guides. The cable storage device is configured for storing slack cable; providing physical protection for the stored slack cable; providing physical and visual access to the stored slack cable; storing a plurality of cable types and sizes; delivering a uniform installation practice for storing slack cables; providing protection from cable bend radius violations; accommodating easy installation and removal; providing a single unit slack cable storage device; and being movable to a plurality of positions. In an embodiment, the cable storage device further includes one or more offset strand brackets fixedly attached to the device frame and configured for engagement with a cable strand for mounting the cable storage device.

### CROSS-REFERENCE TO RELATED APPLICATIONS

This application claims priority pursuant to 35 U.S.C. 119(e) to co-pending U.S. Provisional Patent Application Ser. No. 63/438,728, filed Jan. 12, 2023, the entire disclosure of which is incorporated herein by reference.

### FIELD OF THE INVENTION

The present invention relates generally to the practice of storing slack cable. More specifically, the present invention is concerned with a slack cable storage device configured to be mounted from a cable strand and adaptable for a variety of configurations and cable types.

### BACKGROUND OF THE INVENTION

Fiber optics utilize light as a carrier wave to transmit data through flexible, optically pure fibers of glass or plastic. Such pulses of light across fiber optic cables are responsible for spreading a significant amount of information throughout the digital globe. Fiber optic networks are a preferred mode of transmitting data because of their versatility, high bandwidth, ability to transmit data over long distances, and immunity to electromagnetic and radio frequency interference. In view of these and other advantages, fiber optics have largely replaced copper wire communications since their development in the 1970s.

The global exchange of data over fiber optic cables is accomplished through intricate networks. Moreover, the everchanging demands of network design—such as network expansion, reconfiguration, and cost—not only require these networks to be flexible but also that they maintain a reliable infrastructure. Additionally, fiber optic networks must be designed in such a way that allows for further interconnection and expansion. In response to these requirements, it is often desired to install and keep an additional, spare amount of excess fiber optic cable at various locations throughout the network. This excess cable is often referred to as slack cable and is used to make splices, repairs, expansions, and/or interconnections when required. As such, this slack cable must be managed and protected so that it remains readily available when needed. There are four critical elements of fiber optic slack cable management: (1) access to the cable, (2) protection from damage, (3) routing, and (4) bend radius protection. These elements are directly correlated to the network's reliability, flexibility, cost, and management.

Current methods of fiber optic slack cable management generally consist of either storing slack cable using storage coils or using a “snowshoe” type, aerial storage system. If storing with storage coils, the method consists of coiling up slack fiber optic cable into a helical or generally circular configuration and securing the coil with cable ties or the like. The coiled cable is then fastened to either a utility pole, messenger cable, aerial cable, or other structure.

Nevertheless, a significant drawback to coiling fiber optic cable is the risk of violating cable bending radius specifications associated with the type of cable being utilized. Each type of fiber optic cable has a specific fiber bend radius which denotes how sharply a cable can safely bend at any given point. Bending fiber optic cable in excess of its bend radius can result in attenuation and possibly cause permanent damage by creating micro cracks on the glass or plastic fibers. As such, bend radius violations often occur when using slack coils because of the lack of structure to define and keep the fiber optic cable within its bend radius parameters. Accordingly, there is a need for a slack storage system that protects against bend radius violations.

Another significant drawback to coiling excess fiber optic cable is that such slack coils are susceptible to physical damage. Being that the design and construction of fiber optic cable incorporates glass or plastic fibers, fiber optic cable is more delicate than metallic wiring, thus increasing its susceptibility to physical damage. Often, slack coils are secured to locations where they can be easily damaged from contact by personnel, animals, and/or environmental factors. Without a defined structure to maintain the integrity of the slack cable, damage often results. Accordingly, there is a need for a slack storage system that protects from physical damage.

Another significant drawback of storage coils is a lack of uniformity when coiling the slack cable. Methods of coiling slack cable vary depending on the field worker, type of cable, owner requirements, and other factors. As such, slack coils may differ significantly from one installation to another, which can lead to confusion amongst field workers, more time-consuming work, or other issues. Accordingly, there is a need for a slack storage system that provides a uniform method of storing slack cable.

Snowshoe fiber optic cable storage units include a rounded teardrop-shape outline that resembles the shape of a snowshoe. Snowshoe storage units allow for slack cable to be stored out in the span of an aerial cable in contrast with storing the slack cable on a utility pole. Typical installations include two snowshoe units installed at a distance away from each other on or near the aerial cable. The two snowshoe units support opposed ends of a loop of slack cable, and the slack fiber optic cable is stretched between each snowshoe unit and is secured to the aerial cable by means of cable ties or the like.

A significant drawback of snowshoe fiber storage units is that typical configurations require the installation of two snowshoe units out in the span of the aerial cable. As such, snowshoe fiber optic cable storage units are time consuming to install and remove as needed. Installing two units results in increased cost due to installation time as compared to single unit systems. Accordingly, there is a need for a slack cable storage system that encompasses a single unit system.

Another drawback to installing snowshoe units in the span of aerial cable is that later access to the units may be restricted by obstacles not present when installed. Moreover, snowshoe fiber optic cable storage units installed away from a utility pole can expose field workers to additional hazards and may be dangerous to access later. Accordingly, there is a need for a slack cable storage system that provides a single unit design which can be installed in a variety of applications.

Another drawback to snowshoe systems is increased labor and installation cost. Installing or removing two snowshoe units out in the span of aerial cable may require additional equipment and labor. These factors directly impact snowshoe unit installation and removal costs and, as such, correspondingly necessitate increased labor cost. Accordingly, there is a need for a slack cable storage system that minimizes installation and removal time, is easily installed and removed, and incorporates a single unit system.

Another disadvantage of snowshoe fiber optic cable storage units is that they lack adjustability to accommodate varying cable sizes and lengths. Storing the slack cable between two snowshoe units out in the span of the aerial cable restricts the amount of slack cable that can be stored because the available area of the aerial span is limited. Moreover, some snowshoe units do not provide accommodations for different types and sizes of cable. As such, cable bend radius violations may occur unless different snowshoe units are installed. Accordingly, there is a need for a slack cable storage system that accommodates a variety of cable sizes.

In addition to slack coils and snowshoe-type fiber optic cable storage units, utility pole-mounted units for storing slack cable are available. Nevertheless, such pole-mounted slack cable storage units can be unsightly when mounted to a utility pole. Moreover, wrapping excess cable from an aerial strand and accessing wrapped cable from a utility pole-mounted unit can be inconvenient or difficult for utility workers. Accordingly, there is a need for an easily accessible cable-mounted slack cable storage system or more easily accessible pole-mounted slack cable storage system.

For the foregoing reasons, there is a need for a slack cable storage device that provides cable bend radius protection, protection from physical damage, uniformity in installation, a single unit design, usability for various cable sizes and types, access to the slack cable, and a system that prioritizes safety and ease of use. Heretofore there has not been available a system or method for storing slack cable with the advantages and features of the present invention.

### SUMMARY OF THE INVENTION

The present invention comprises a cable storage device and method for securing and storing an amount of slack cable. In an exemplary embodiment of the present invention, the cable storage device comprises a selectively mountable frame configured for receiving and storing an amount of slack cable, providing protection to stored slack cable, and being easily installed and removed. It is an object of the present invention to provide a device and method for storing an amount of slack cable. In a preferred embodiment, the cable storage device of the present invention is configured for being mounted directly from a strand of cable, either from the same cable being stored or from a messenger cable. In alternative embodiments, the cable storage device of the present invention is configured for being mounted from a pole or other structure. In an exemplary embodiment, the present invention is utilized to store and mount cable such as but not limited to fiber optic cable.

In one embodiment of the instant invention, the present invention satisfies the need for a slack storage system having protection from cable bend radius violations. In another embodiment, the present invention satisfies the need for a slack storage system having protection from physical damage to the cable. In yet another embodiment, the present invention satisfies the need for a slack storage system that provides a uniform installation practice of storing slack cables. In an embodiment, the present invention satisfies the need for a slack storage system that is easily installed, thereby reducing overall installation and removal cost. In another embodiment, the present invention satisfies the need for a slack storage system with versatility to store different cable sizes. Further still, in an embodiment, the present invention satisfies the need for a slack storage system that can be installed in a plurality of locations.

In an exemplary embodiment, the cable storage device of the present invention includes a frame which mounts a series of cable guides positioned in such a way to accommodate secure storage of a cable while maintaining a safe cable bend radius. In an embodiment, the frame includes an extended member having first and second ends which forms the spine of a cable slack storage device.

In an exemplary embodiment, the frame of the present invention further includes one or more cross-arm members. In an exemplary embodiment, the one or more cross-arm members comprise one or more cross-arm brackets. In an exemplary embodiment, the present cable storage device includes two cross-arm members, which in combination with the spine of the present invention form an H-frame shape. Nevertheless, in other embodiments, the frame of the present invention forms an alternative shape.

In an exemplary embodiment of the present invention, the cable slack storage device frame includes one or more cable guides. In some embodiments, the cable guides are affixed to opposing ends of one or more cross-arm brackets. In an exemplary embodiment, cable guides of the present device are attached to one or more cross-arm members in such positions to help prevent violations of the minimum cable bend radius of the cable to be stored and mounted. In a preferred embodiment, a cable guide extends outward from each end of each cross-arm member, for a total of four cable guides, each cable guide extending outward distally at an approximate 45-degree angle from its respective attached cross-arm member.

In an embodiment of the present invention, the slack cable storage device includes one or more offset strand brackets. In an exemplary embodiment, each offset strand bracket is generally C-shaped having a base configured for attachment to a spine and/or a cross-arm member of the cable storage device and having a strand mounting clamp opposite the offset strand bracket base. In such embodiments, the strand mounting clamp is configured for securely clamping around a cable or other strand via fasteners to mount the cable storage device from the cable or other strand without damage to the cable or other strand. In a preferred embodiment, the cable storage device includes two offset strand brackets, each having a strand mounting clamp for suspension of the device from a cable or other strand.

In an exemplary embodiment of the present invention, the cable slack storage device is removably attached to a cable, such as, but not limited to, a messenger cable or the like. In an embodiment, the cable slack storage device is removably attached to a cable by means of the one or more offset strand brackets.

In an alternative embodiment of the present invention, the slack cable storage device is configured for attachment to a rounded post or rod, such as but not limited to a utility pole, rather than being mounted to a messenger or other cable. In further embodiments, the slack cable storage device is configured for attachment to a flat surface.

The instant invention provides a versatile cable slack storage device that is suitable for a variety of applications, including, but not limited to: providing storage in a plurality of mounting configurations for an amount of slack cable to be stored; physical protection for an amount of slack cable; protection from cable bend radius violations; a method of uniform slack cable storage; easy installation and removal; a single unit slack cable storage system; a slack cable storage system that is configured for a variety of cable sizes and types; a slack cable storage system that can be installed in a plurality of locations; physical and visual access to the stored slack cable; and movability to a plurality of positions.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

Embodiments of the present invention are described in detail below with reference to the attached drawing figures, wherein:

FIG. 1 is an upper, perspective view of a cable storage device embodying the present invention.

FIG. 2 is a bottom, perspective view of the cable storage device.

FIG. 3 is a top, plan view of the cable storage device.

FIG. 4 is a bottom, plan view of the cable storage device.

FIGS. 5-6 are end, elevational views of the cable storage device.

FIGS. 7-8 are side, elevational views of the cable storage device.

FIG. 9 is an upper, perspective, exploded view of the cable storage device.

FIG. 10 is a lower, perspective view of an offset mounting bracket of the cable storage device.

FIG. 11 is an upper, perspective, assembled view of an offset mounting bracket affixed to a frame of the cable storage device.

FIG. 12 is an upper, perspective, exploded view of the offset mounting bracket, illustrating an associated mounting clamp.

FIG. 13 is an upper, perspective view of the cable storage device storing an amount of cable.

FIG. 14 is a top, plan view of the cable storage device storing an amount of cable.

FIGS. 15-16 are end, elevational views of the cable storage device storing an amount of cable.

FIGS. 17-18 are side, elevational views of the cable storage device storing an amount of cable.

FIG. 19 is an upper, perspective view of an embodiment of a pole-mountable cable storage device of the present invention.

FIG. 20 is a top, plan view of the pole-mountable cable storage device.

FIG. 21 is an upper, perspective view of the cable storage device storing an amount of cable and mounted to a pole.

FIG. 22 is an elevational view of the cable storage device storing an amount of cable and mounted to a pole.

The drawing figures do not limit the present invention to the specific embodiments disclosed and described herein. The drawings are not necessarily to scale, emphasis instead being placed upon illustrating the principles of the invention.

### DETAILED DESCRIPTION OF THE PREFERRED EMBODIMENTS

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The present invention comprises a cable storage device for receiving, storing, and securing an amount of slack cable and methods thereof. In an exemplary embodiment, the cable storage device comprises a rigid frame mounting a series of cable guides which extend out radially from the center of the frame and configured to receive an amount of cable.

In an exemplary embodiment of the present invention, the cable storage device comprises an H-shaped frame configured to receive and store an amount of slack cable, to provide slack cable protection, and to be easily installed and removed. Nevertheless, in alternative embodiments of the present invention, the cable storage device comprises a T-shaped, X-shaped, square-shaped, rectangular, triangular, circular, oval-shaped, or any other shape frame configured for receiving and storing slack cable.

In an exemplary embodiment, the cable storage device of the present invention is configured for being selectively mounted directly from a strand of cable. Such mounting cable can be a strand of the cable being stored by the device, a messenger cable, or any other cable. In other embodiments, the cable storage device is configured to be mounted from a pole or other structure. In an exemplary embodiment, the present invention is utilized to store and mount fiber optic cable. In other embodiments, the present invention is used for storing and mounting other types of cable, including but not limited to coaxial cable, unshielded twisted pair (UTP), shielded twisted pair (STP), single-mode fiber, multi-mode fiber, direct-buried cable, or any other type of cable to be stored.

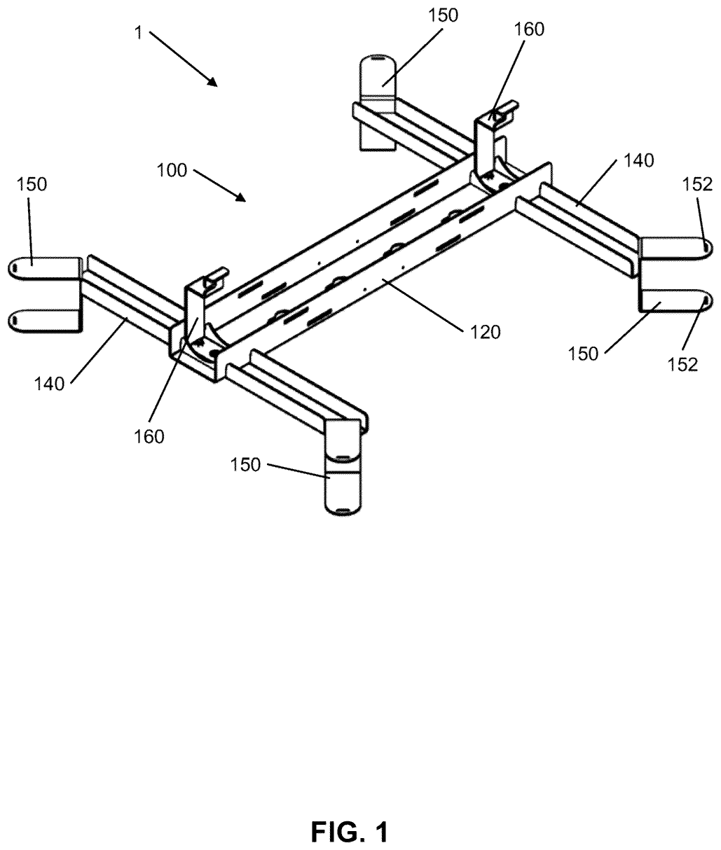

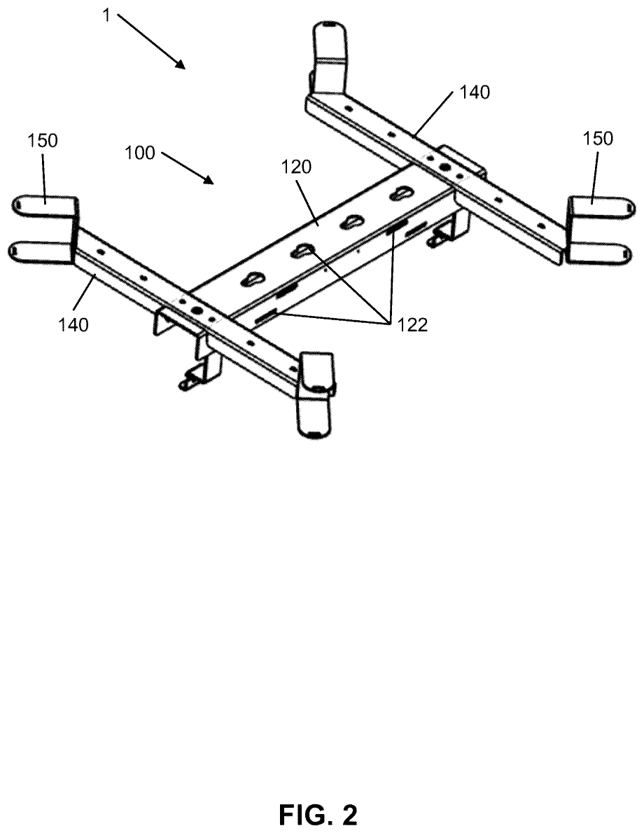

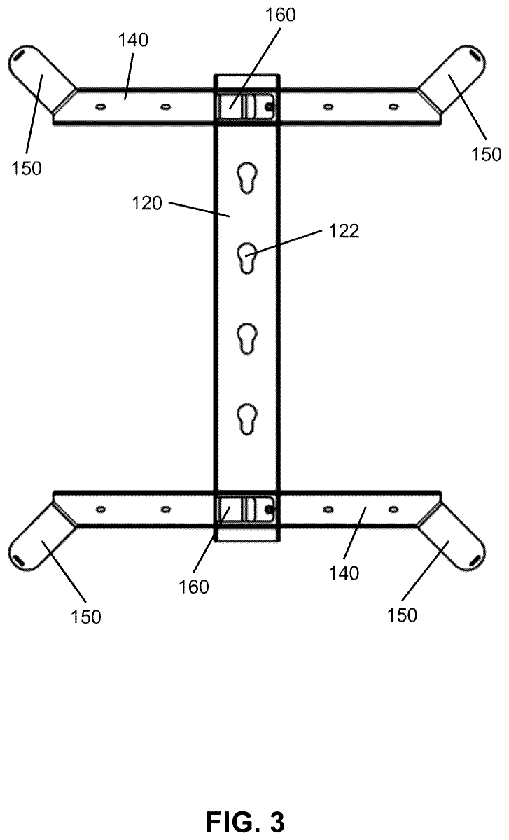

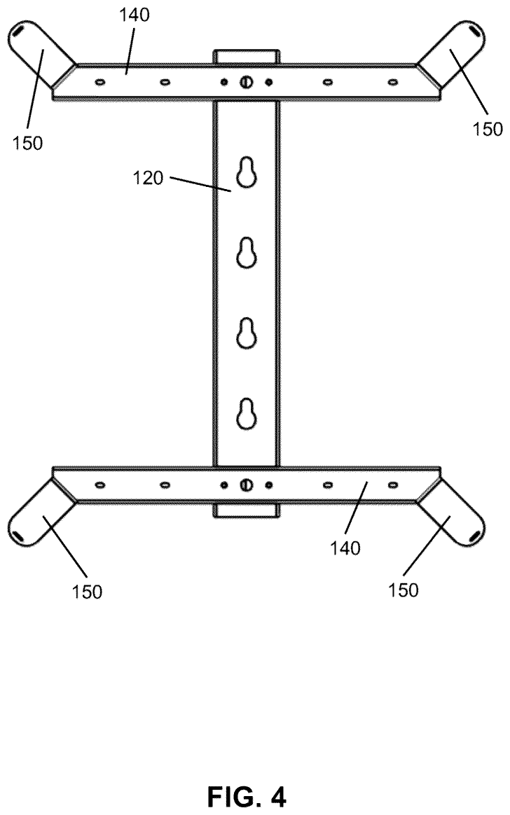

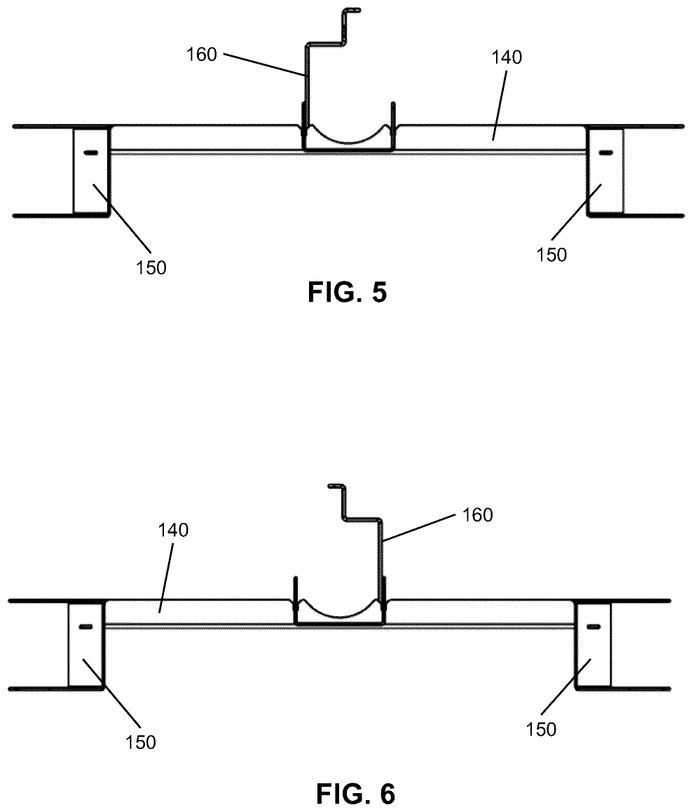

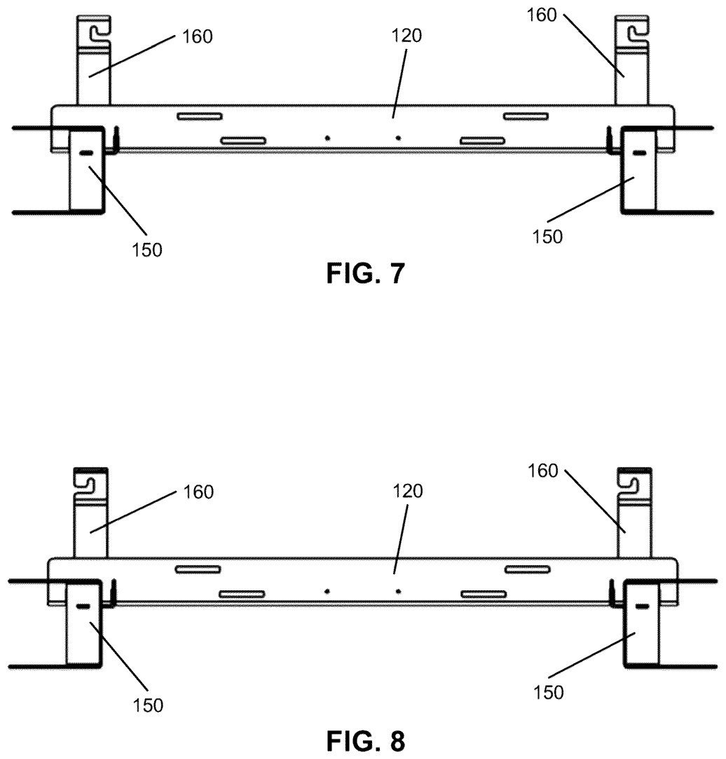

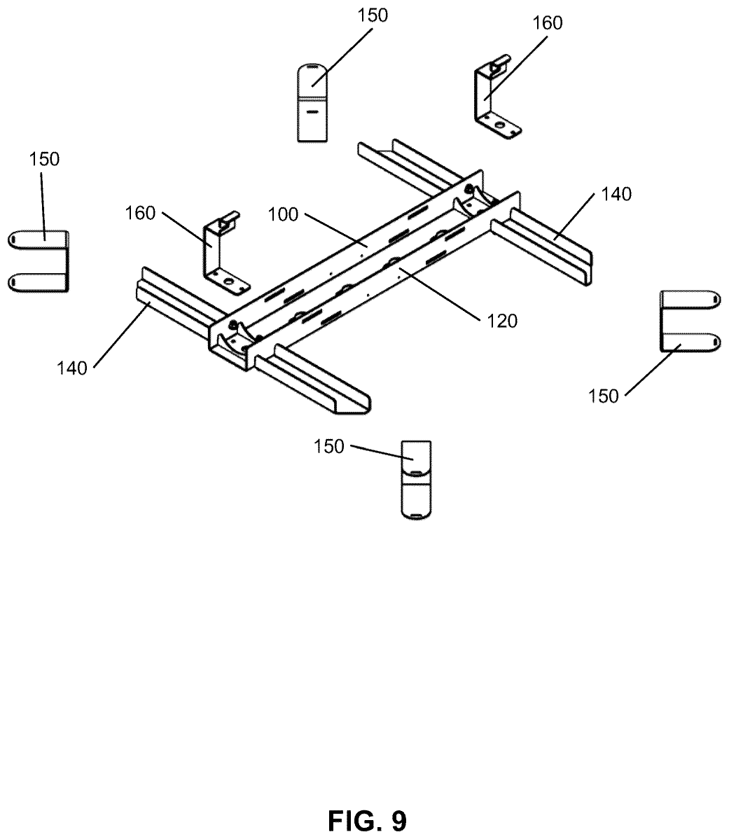

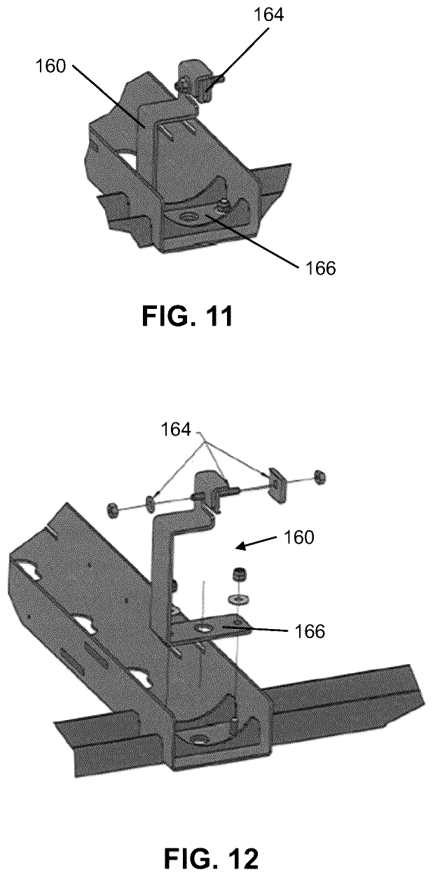

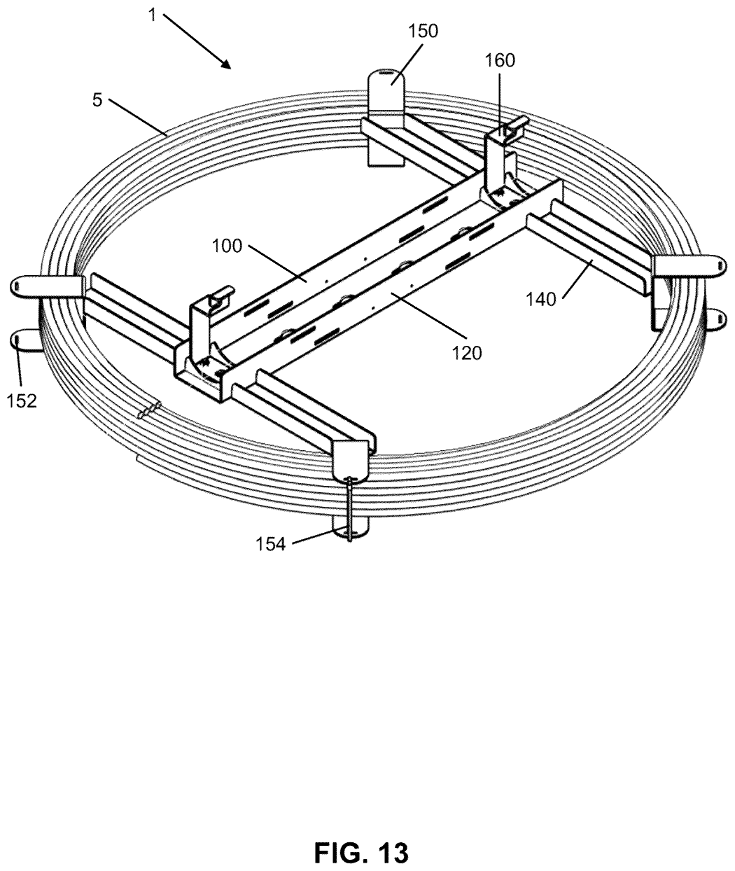

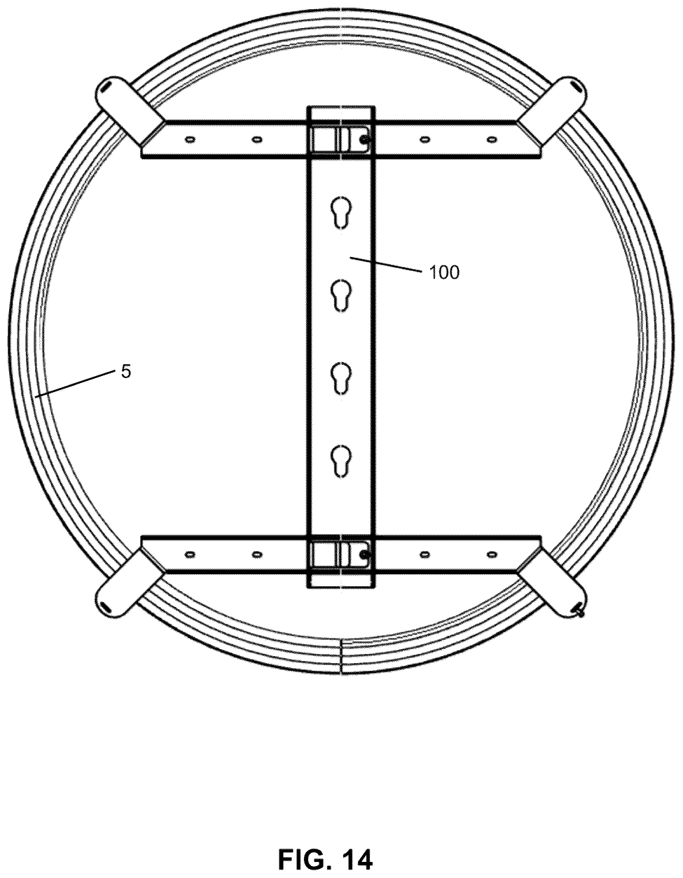

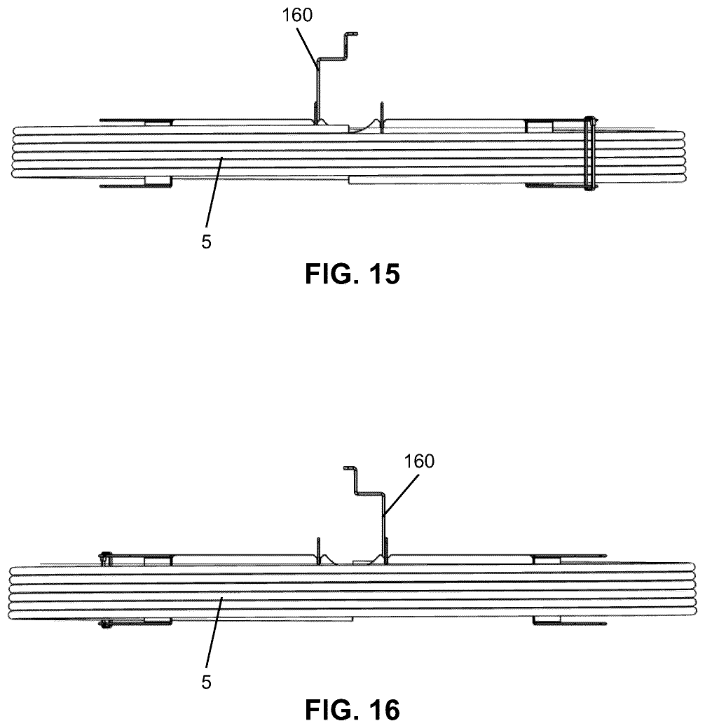

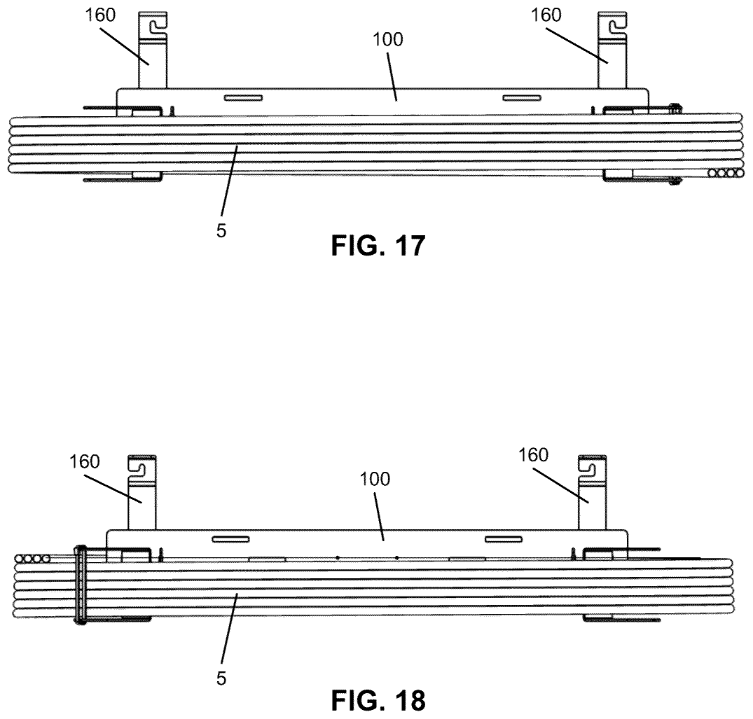

Referring to the drawings, FIGS. 1-18 show an exemplary embodiment of a cable storage device 1 of the present invention. FIGS. 1-8 show views of the assembled cable storage device 1 in this embodiment. FIG. 9 shows an exploded view of the cable storage device 1. FIGS. 13-18 show views of this embodiment of the cable storage device 1 storing an amount of cable 5.

In an embodiment, the cable storage device 1 comprises a frame 100 including an extended member having first and second ends forming the spine 120 of the cable storage device 1. In some embodiments, the spine 120 is a bracket. In an exemplary embodiment, the spine 100 includes a channel extending between the first end and second end of the spine 120. In other embodiments, the spine top, bottom, and sides are generally enclosed with no channel. In some embodiments, the cable storage device spine is a U-shaped channel member. In further embodiments, the spine is defined by other types of channel members such as but not limited to a flat channel member, an H-shaped channel member, or the like.

In an embodiment, the spine 120 includes a plurality of apertures 122 which accommodate fastening the spine to an object or surface. In other embodiments of the present invention, the spine does not include apertures. In some embodiments, a plurality of apertures 122 defined through the spine 120 are slots such that a strap, cable tie, band, or the like can be fed through to secure the spine 120 to an object or surface. In some embodiments, a plurality of apertures are holes defined through the spine such that a bolt, screw, or the like can be fed though and attached to secure the spine to a surface. In some embodiments, a plurality of apertures defined by the spine are a combination of holes, slots, and/or other voids. In other embodiments, a plurality of apertures defined through the spine are utilized to secure cable to the spine. In other embodiments, a plurality of apertures defined through the spine are keyed slots configured to assist in securing the spine to a surface. In some embodiments, a plurality of apertures defined through the spine are keyed slots configured for use to secure the spine to an enclosure such as a splice case. In some embodiments, a plurality of apertures defined through the spine 120 are utilized for securing the spine to a bracket, cross-arm, or the like. In embodiments, the spine 120 includes sidewalls and a base wall or floor. In embodiments, the spine further includes a front wall, a back wall, a top wall, or combinations thereof. In embodiments, the spine includes apertures such as cutouts, slits, slots, grooves, or the like for securing a bracket, cross-arm, or the like to the spine.

In an exemplary embodiment, the frame 100 of the cable storage device further includes one or more cross-arm members 140 fixedly connected to the spine 120. In an exemplary embodiment, the one or more cross-arm members 140 comprise one or more cross-arm brackets. In an exemplary embodiment, the present cable storage device 1 includes two cross-arm members 140, which in combination with the spine 120 of the present invention form an H-frame shape. In an exemplary embodiment, the cross-arm members 140 are bolted to the spine 120 of the frame 100 of the present cable storage device 1. In embodiments, the spine 120 includes cross-arm receiver slots and each cross-arm member 140 includes notches configured for engaging with the receiver slots. In such embodiments, during assembly of the frame 100 of the device, the cross-arm members 140 are aligned with the receiver slots on the spine 120, each cross-arm member 140 near one of the first and second ends of the spine 120, and the cross-arm members 140 are then fixedly bolted to the spine 120 with fasteners, such as but not limited to bolts, studs, nuts, welds, or the like. In alternative embodiments, the frame spine 120 and cross-arm members 140 are molded together or are of uniform body. In further embodiments, the cross-arm members 140 are welded to the spine 120. In some embodiments, each cross-arm member 140 comprises one or more concave engagement sections configured to engage one or more cross-arm receiving slots of the spine. Additionally, such concave engagement sections further accommodate use of the present device in a pole mounted configuration because they allow for closer mounting to a round pole or object.

In some embodiments, each cross-arm member 140 includes a channel extending from end to end. In other embodiments, each cross-arm member is generally enclosed with no channel. In some embodiments, each cross-arm member is defined by a U-shaped channel member. In other embodiments, each cross-arm member is defined by other types of channel members such as but not limited to flat channel member, an H-shaped channel member, or the like.

In some embodiments of the present invention, the one or more cross-arm members 140 each include a plurality of apertures for fastening the cross-arm member 140 to a surface. In other embodiments, the cross-arm members do not define any apertures. In some embodiments, a plurality of apertures defined through one or more cross-arm members are slots such that a strap, cable tie, band, or the like can be fed through to secure the one or more cross-arm members to a surface. In some embodiments, a plurality of apertures defined through one or more cross-arm members are holes such that a bolt, screw, or the like can be fed through and attached to secure the one or more cross-arm members to a surface. In some embodiments, a plurality of apertures defined through one or more cross-arm members are a combination of holes, slots, and other voids. In other embodiments, a plurality of apertures defined through one or more cross-arm members are utilized to secure cable to the one or more cross-arm members. In other embodiments, a plurality of apertures defined through one or more cross-arm members are keyed slots configured for assisting in securing the one or more cross-arm members to a surface. In some embodiments, a plurality of apertures defined through one or more cross-arm members are keyed slots configured for use to secure the one or more cross-arm members to an enclosure such as a splice case. In some embodiments, a plurality of apertures defined through one or more cross-arm members are utilized for securing the one or more cross-arm members to a bracket, spine, or the like. In embodiments, each cross-arm member includes sidewalls and a base wall or floor. In embodiments, each cross-arm member further includes a front wall, a back wall, a top wall, or combinations thereof. In embodiments, the one or more cross-arm members include apertures such as cutouts, slits, slots, or the like for securing a bracket, spine, or the like to the one or more cross-arm brackets.

In an exemplary embodiment of the instant invention, the cable storage device 1 includes one or more cable guides 150. In embodiments, cable guides 150 are positioned outward radially from the center of the frame 100 so as to receive and guide an amount of slack cable 5 to be stored securely at a safe bend radius for the cable. In embodiments, the cable guides 150 are affixed to opposing ends of one or more cross-arm members 140. In some embodiments, the cable guides 150 are of uniform structure with the one or more cross-arm members 140. In some embodiments, a single cable guide is utilized. In other embodiments, two, three, four, five, six, seven, eight, or more cable guides are utilized. In an exemplary embodiment, cable guides 150 of the present device are fixedly attached to one or more cross-arm members 140 in such positions to help prevent violations of the minimum cable bend radius of the cable 5 to be stored and mounted. In embodiments, the cable guides 150 are each affixed to a respective cross-arm member 140 via fasteners, molded together with a respective cross-arm member 140 or entire frame 100, or are welded to a respective cross-arm member 140.

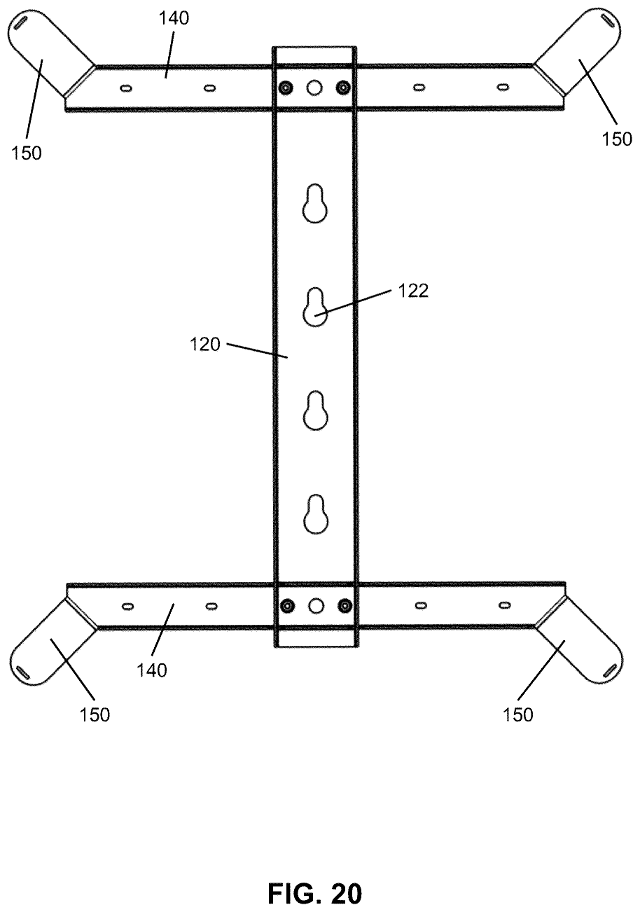

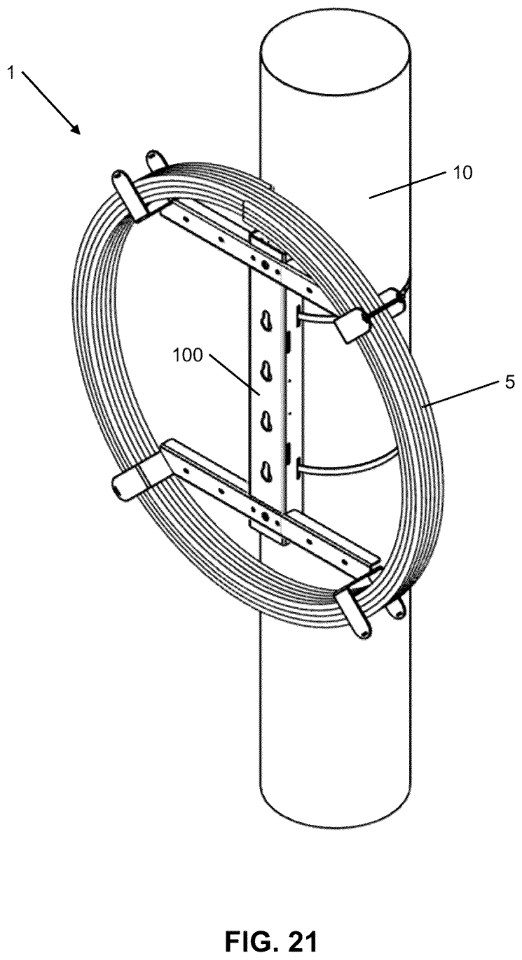

In a preferred embodiment, a cable guide 150 extends outward from each end of each cross-arm member 140, for a total of four cable guides 150, each cable guide 150 extending outward distally at an angle from its respective attached cross-arm member 140 away from the center of the frame 100, as shown in FIGS. 1-8 and 13-22. In an exemplary embodiment, the cable guides 150 each extend outward distally at approximately a 45-degree angle from its respective attached cross-arm member 140. In other embodiments, the angle of the cable guides 150 relative to the cross-arm member 140 mounting it can vary between 0-degrees (i.e., parallel to the respective cross-arm member 140) and 90-degrees.

In embodiments of the present invention, cable guides 150 are configured for varying sizes of cable diameters and bend radiuses. In some embodiments, the cable guide 150 further comprises a plurality of cable support tabs, a plurality of cable steps, and a plurality of apertures. In some embodiments, each cable guide includes one or more cable support tabs. In some embodiments, cable support tabs are affixed to a cable guide. In other embodiments, cable support tabs are removably attached to a cable guide.

In an exemplary embodiment, each cable guide 150 is generally U-shaped and opens outward, as shown in FIGS. 1-8 and 13-22. In alternative embodiments, cable guides can form any other shape configured to receive and store wrapped layers of cable. In an exemplary embodiment, each cable guide 150 defines apertures 152, such as but not limited to banding slots, configured to allow a user to band or lock in an amount of slack cable within the device with a band 154, a strap, or the like.

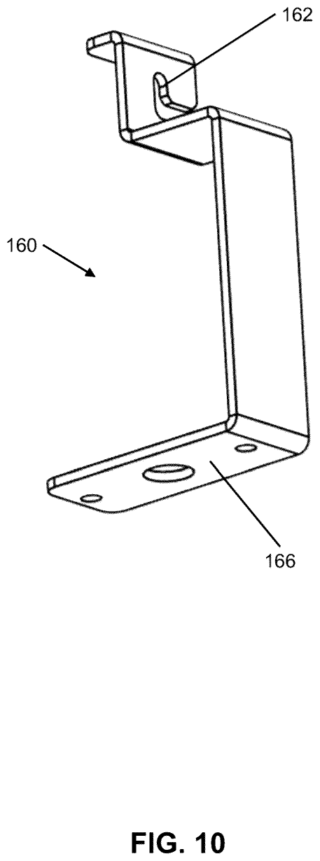

In an exemplary embodiment of the present invention, the cable storage device 1 further includes one or more offset strand brackets 160 configured for fixed attachment to the frame 100 and selective mounting onto a cable strand. In an exemplary embodiment of the present invention, each offset strand bracket 160 is generally C-shaped having a base 166 configured for attachment to the spine 120 and/or a cross-arm member 140 of the cable storage device 1 and having a strand mounting groove 162 and associated mounting clamp 164 opposite the offset strand bracket base 166. In such embodiments, the strand mounting clamp 164 is configured to securely clamp around a cable or other strand via clamp fasteners to mount the cable storage device 1 from the cable or other strand without damage to the cable or other strand. In a preferred embodiment, the cable storage device 1 includes two offset strand brackets 160, each having a strand mounting clamp 164 for suspension of the device 1 from a cable or other strand. FIGS. 1-18 illustrate an embodiment of the present cable storage device 1 including two offset strand brackets 160, with FIGS. 10-12 illustrating aspects of an offset strand bracket 160 specifically. In alternative embodiments, the cable storage device 1 includes one, three, four, five, six, or any other number of offset strand clamps for suspension of the device from a cable or other strand.

In alternative embodiments, each offset strand bracket 160 comprises a U-shaped channel member. In other embodiments, each offset strand bracket comprises another type of channel member such as, but not limited to, a flat channel member, an H-shaped channel member, or the like.

In some embodiments, an offset strand bracket 160 includes one or more apertures. In some embodiments, an offset strand bracket 160 includes a base 166 configured to engage with the spine and/or a cross-arm member of the cable storage device. In some embodiments, the base 166 includes one or more apertures. In some embodiments, an offset strand bracket base 166 comprises one or more apertures configured for engagement with a lag bolt, welded stud, or the like. In some embodiments, an offset strand bracket includes a main body. In some embodiments, an offset strand bracket of the instant invention includes an end portion of the offset strand bracket base fixedly attached to an end portion of the offset strand bracket main body. In some embodiments, an offset strand bracket includes a support arm. In some embodiments, an offset strand bracket main plate end portion is fixedly attached to a support arm end portion. In some embodiments, an offset strand bracket includes a connection plate. In some embodiments, a support arm end portion is fixedly attached to a connection plate end portion. In some embodiments, an offset strand bracket connection plate comprises an aperture configured to engage a clip, bolt, stud, fastener, or the like. In some embodiments, an offset strand bracket further comprises a tab. In some embodiments, a tab end portion is fixedly attached to a connection plate end portion.

In an exemplary embodiment of the present invention, one or more offset strand brackets 160 are fixedly attached to the cable storage device frame 100. In some embodiments, one or more offset strand brackets 160 are removably attached to the frame 100. In some embodiments, one or more offset strand brackets 160 engage the spine 120 of the cable storage device 1. In some embodiments, one or more offset strand brackets 160 engage one or more cross-arm members 140 of the cable storage device 1. In some embodiments, offset strand bracket(s) 160 engage the spine 120 and one or more cross-arm members 140 of the cable storage device 1. In some embodiments, one or more offset strand brackets 160 are attached to the frame 100 by a fastener such as, but not limited to, a bolt, welded stud, nut, or the like. In some embodiments, each offset strand bracket 160 engages the cable storage device frame 100 at a location at or near one or more apertures, slots, one or more cross-arm receiving slots, one or more concave engagement sections, or the like.

In an embodiment of the present invention, the cable storage device 1 is removably attached to a cable, such as, but not limited to, a messenger cable or the like. In an embodiment, the cable storage device 1 is removably attached to a cable by means of the one or more offset strand brackets 160. In an embodiment, the cable storage device 1 is removably attached to a cable by means of, but not limited, to a strap, cable tie, band, bolt, nut, stud, hanger, clamp(s), or the like.

In an exemplary embodiment of the present invention, the cable storage device 1 is further configured to be pivotally movable between a stowed position and one or more access positions while being mounted to a cable or other structure or surface. In an exemplary embodiment, the stowed position of the cable slack storage device is configured to be approximately longitudinally parallel to the cable or other structure or surface from which the cable storage device is mounted, and the one or more access positions are configured to provide a user easier access to the slack cable for removal or addition of slack cable. In an embodiment, the cable storage device is capable of being movably positioned and adjusted along, or parallel to, its vertical axis. In another embodiment, the cable storage device is capable of being movably positioned and adjusted along, or parallel to, its horizontal axis. In another embodiment, the cable storage device is capable of being movably positioned and adjusted along, or parallel to, both its vertical axis and horizontal axis.

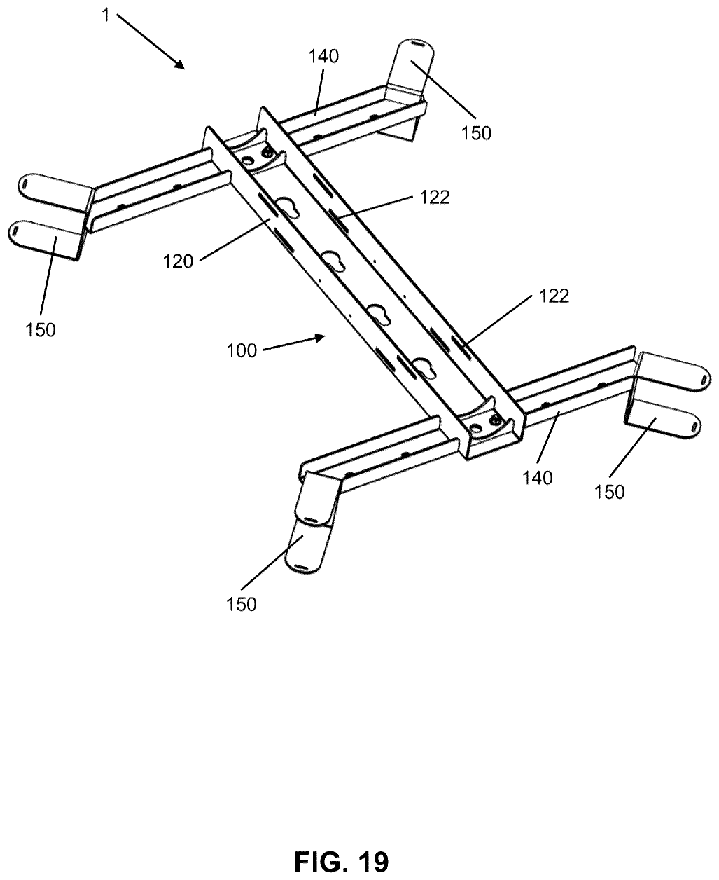

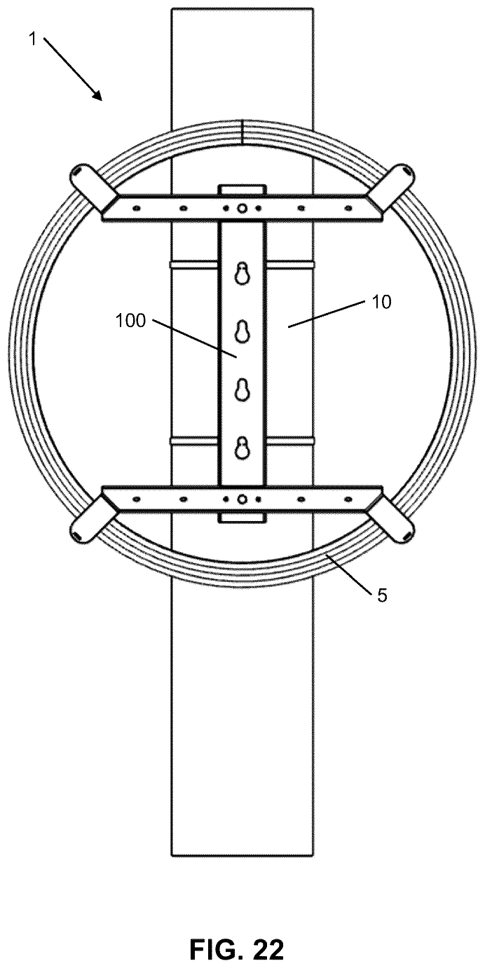

In an alternative embodiment of the present invention, as shown in FIGS. 19-22, the cable storage device 1 is configured for attachment to a rounded post or rod 10, such as but not limited to a utility pole, rather than being mounted to a messenger or other cable. In an exemplary embodiment, the cable storage device 1 is configured to be selectively attached to a post 10 or rod via one or more bands or the like threaded through apertures 122 on the frame 100 of the cable storage device 1 and fastened around the post 10 or rod, as shown in FIGS. 21-22. In further embodiments, the cable storage device 1 is configured for attachment to a flat surface.

In an embodiment of the present invention, the cable storage device 1 provides a user physical access to stored slack cable 5. In an embodiment, the cable storage device 1 provides visual access to stored slack cable 5.

In an embodiment, the cable storage device 1 of the present invention is formed from a uniform material. In another embodiment of the present invention, the cable storage device 1 is formed from a plurality of materials. In embodiments, the cable storage device 1 is comprised of materials such as, but not limited to, metal, rigid plastic, rigid composite materials, or the like. In an exemplary embodiment, the cable storage device 1 is comprised of corrosion resistant steel. In an exemplary embodiment of the present invention, the cable storage device 1 is powder-coated to provide protection against corrosion.

Certain terminology is used in the description for convenience in reference only and will not be limiting. For example, up, down, front, back, right, and left refer to the invention as orientated in the view being referred to. The words “inwardly” and “outwardly” refer to directions toward and away from, respectively, the geometric center of the aspect being described and designated parts thereof. Forwardly and rearwardly are generally in reference to the direction of travel, if appropriate. Additionally, anatomical terms are given their usual meanings. For example, proximal means closer to the trunk of the body, and distal means further from the trunk of the body. Said terminology shall include the words specifically mentioned, derivatives thereof, and words of similar meaning.

As used in this specification and the appended claims, the singular forms “a”, “an”, and “the” include plural references unless the context clearly dictates otherwise. Thus, for example, a reference to “a method” includes one or more methods, elements, and/or steps of the type described herein and/or which will become apparent to those persons skilled in the art upon reading this disclosure and so forth.

As used in this specification and the appended claims, the use of the term “about” means a range of values including and within 15% above and below the named value, except for nominal temperature. For example, the phrase “about 3 mM” means within 15% of 3 mM, or 2.55-3.45, inclusive. Likewise, the phrase “about 3 millimeters (mm)” means 2.55 mm-3.45 mm, inclusive. When temperature is used to denote change, the term “about” means a range of values including and within 15% above and below the named value. For example, “about 5° C.,” when used to denote a change such as in “a thermal resolution of better than 5° C. across 3 mm,” means within 15% of 5° ° C., or 4.25° C.-5.75° C. When referring to nominal temperature, such as “about −50° ° C. to about ±50° ° C.,” the term “about” means±5° ° C. Thus, for example, the phrase “about 37° C.” means 32° C.-42° ° C.

Unless defined otherwise, all technical and scientific terms used herein have the same meaning as commonly understood by one of ordinary skill in the art to which this invention belongs. Although any systems, elements, methods and materials similar or equivalent to those described herein can be used in the practice or testing of the present invention, the preferred systems, elements, and methods and materials are now described. All publications mentioned herein are incorporated herein by reference to describe in their entirety.

“Substantially” means to be more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder. “Comprising,” “including,” and “having” (and conjugations thereof) are used interchangeably to mean including but not necessarily limited to, and are open-ended terms not intended to exclude additional, unrecited elements or method steps.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

It is also to be understood that the following claims are intended to cover all of the generic and specific features of the invention herein described, and all statements of the scope of the invention which, as a matter of language, might be said to fall therebetween.

Having thus described the invention, what is claimed as new and desired to be secured by Letters Patent is:

1. A cable storage device comprising:
a frame comprising an elongated spine having first and second ends and one or more elongated cross-arm members, each cross-arm member having first and second ends, and wherein each cross-arm member is fixedly attached to said spine;
said frame mounting a plurality of cable guides positioned outward from said frame and configured to receive and retain an amount of slack cable within said plurality of cable guides in such a configuration to maintain at least a minimum bend radius of the slack cable; and
one or more offset mounting brackets, each offset mounting bracket having a base fixedly attached to said frame and a mounting clamp opposite said base configured for selective engagement with a cable strand for mounting said cable storage device from said cable strand.

2. The cable storage device of claim 1, wherein:
said one or more cross-arm members comprises a first cross-arm member and a second cross-arm member;
said first cross-arm member is fixedly attached to said spine near said first end of said spine; and
said second cross-arm member is fixedly attached to said spine near said second end of said spine.

3. The cable storage device of claim 2, wherein:
said plurality of cable guides comprises a first cable guide, a second cable guide, a third cable guide, and a fourth cable guide;
said first cable guide is mounted from the first end of said first cross-arm member;
said second cable guide is mounted from the second end of said first cross-arm member;
said third cable guide is mounted from the first end of said second cross-arm member; and
said fourth cable guide is mounted from the second end of said second cross-arm member.

4. The cable storage device of claim 3, wherein:
each of said first cable guide and said second cable guide extend outward distally at approximately a 45-degree angle from said first cross-arm member; and
each of said third cable guide and said fourth cable guide extend outward distally at approximately a 45-degree angle from said second cross-arm member.

5. The cable storage device of claim 1, wherein:
each of said cable guides is generally U-shaped with an opening facing outward from a center of said frame.

6. The cable storage device of claim 1, wherein:
each of said cable guides defines first and second apertures configured to allow a user to thread a band or a strap therethrough to hold said amount of slack cable within said cable guide.

7. The cable storage device of claim 1, wherein:
said amount of slack cable comprises an amount of slack fiber optic cable.

8. The cable storage device of claim 1, wherein:
said one or more offset mounting brackets comprises a first offset mounting bracket and a second offset mounting bracket;
said first offset mounting bracket is fixedly attached to said spine near said first end of said spine; and
said second offset mounting bracket is fixedly attached to said spine near said second end of said spine.

9. A cable storage device comprising:
an elongated spine having first and second ends;
an elongated first cross-arm member having first and second ends and fixedly attached to said spine near said first end of said spine;
an elongated second cross-arm member having first and second ends and fixedly attached to said spine near said second end of said spine;
a plurality of cable guides comprising a first cable guide mounted and positioned outward from the first end of said first cross-arm member, a second cable guide mounted and positioned outward from the second end of said first cross-arm member, a third cable guide mounted and positioned outward from the first end of said second cross-arm member, and a fourth cable guide mounted and positioned outward from the second end of said second cross-arm member; and
wherein said plurality of cable guides is configured to receive and retain an amount of slack cable within said plurality of cable guides in such a configuration to maintain at least a minimum bend radius of the slack cable.

10. The cable storage device of claim 9, wherein:
each of said first cable guide and said second cable guide extend outward distally at approximately a 45-degree angle from said first cross-arm member; and
each of said third cable guide and said fourth cable guide extend outward distally at approximately a 45-degree angle from said second cross-arm member.

11. The cable storage device of claim 9, wherein:
each of said plurality of cable guides is generally U-shaped with an opening facing outward from a center of said frame.

12. The cable storage device of claim 9, wherein:
each of said plurality of cable guides defines first and second apertures configured to allow a user to thread a band or a strap therethrough to hold said amount of slack cable within said cable guide.

13. The cable storage device of claim 9, wherein:
said spine further comprises a plurality of apertures configured to accommodate mounting said cable storage device from a rounded pole, rounded rod, or flat surface.

14. The cable storage device of claim 9, further comprising:
one or more offset mounting brackets, each offset mounting bracket having a base fixedly attached to said spine and a mounting clamp opposite said base configured for selective engagement with a cable strand for mounting said cable storage device from said cable strand.

15. A method of storing slack cable comprising the steps of:
providing a cable storage device comprising an elongated spine having first and second ends, an elongated first cross-arm member having first and second ends and fixedly attached to said spine near said first end of said spine, an elongated second cross-arm member having first and second ends and fixedly attached to said spine near said second end of said spine, and a plurality of cable guides comprising a first cable guide mounted and positioned outward from the first end of said first cross-arm member, a second cable guide mounted and positioned outward from the second end of said first cross-arm member, a third cable guide mounted and positioned outward from the first end of said second cross-arm member, and a fourth cable guide mounted and positioned outward from the second end of said second cross-arm member; and
wrapping an amount of slack cable around said cable storage device, with the slack cable positioned within said plurality of cable guides such that at least a minimum bend radius of the slack cable is maintained.

16. The method of claim 15, further comprising the steps of:
providing one or more offset mounting brackets, each offset mounting bracket having a base fixedly attached to said spine and a mounting clamp opposite said base; and
clamping said mounting clamp around a cable strand to mount said cable storage device from the cable strand.

17. The method of claim 15, wherein:
said spine further defines a plurality of apertures.

18. The method of claim 17, further comprising the steps of:
threading a band or strap through a portion of said plurality of apertures; and
mountingly wrapping said band or strap around a rounded pole, rounded rod, or flat surface.

19. The method of claim 17, further comprising the step of:
mounting said cable storage device to a surface via one or more fasteners through a portion of said plurality of apertures.
